(19) United States
(12) Patent Application Publication
(10) Pub. No.: US 2003/0146611 A1
(43) Pub. Date: Aug. 7, 2003

(54) Adaptive output passenger disk inflator

(76) Inventors: Steven B. Kenney, Pleasant View, UT (US); Kirk Rasmussen, West Point, UT (US); Kim V. Dahl, Clinton, UT (US)

Correspondence Address: James D. Erickson, Autoliv ASP, Inc., 3350 Airport Road, Ogden, UT, 84405, US

(21) Appl. No.: 10/068,545

(22) Filed: Feb. 6, 2002

(51) Int. Cl. B60R 21/26

(52) U.S. Cl. 280/736

(57) ABSTRACT

A vehicular inflatable restraint system inflator device, particularly a passenger inflator device is provided which includes a housing having a disk form and defining a first chamber. The first chamber in a static state contains a quantity of a first gas generant material ignitable to produce first combustion products including a first inflation gas. The housing has at least two rows of spaced apart gas exit ports adapted to permit passage of the first inflation gas from the inflator device into an associated inflatable airbag cushion. The first chamber also contains at least one inflation gas-permeable treatment element disposed adjacent the spaced apart gas exit ports, wherein passage of gas through the treatment element results in treatment thereof. The first chamber further contains a second chamber which, in a static state, has an enclosed volume containing a quantity of a second gas generant material ignitable to produce second combustion products. The second chamber has a lid closure adapted to permit fluid communication of the second combustion products with the contents of the first chamber. The inflator device also includes a first initiator device operatively associated with the first chamber and a second initiator device operatively associated with the second chamber.

### BACKGROUND OF THE INVENTION

This invention relates generally to inflators for use in inflating inflatable restraint airbag cushions such as used to provide impact protection to occupants of motor vehicles. In particular, the invention relates to passenger inflatable safety restraint inflators, as opposed to driver inflatable safety restraint inflators, and, more specifically, to passenger inflatable safety restraint inflators having a disk shape or form and such as may be used to provide an inflation gas output which is adaptive to factors such as one or more crash and occupant conditions.

It is well known to protect a vehicle occupant using a cushion or bag, e.g., an “airbag,” that is inflated or expanded with gas when the vehicle encounters sudden deceleration, such as in the event of a collision. In such systems, the airbag cushion is normally housed in an uninflated and folded condition to minimize space requirements. Upon actuation of the system, the inflatable restraint cushion begins to be inflated in a matter of no more than a few milliseconds with gas produced or supplied by a device commonly referred to as an “inflator.”

Safety restraint airbag cushions are normally sized and shaped to provide a vehicle occupant with desired cushioning protection when such an airbag cushion has been properly deployed. In a typical airbag module assembly, an airbag cushion is normally stored within a reaction canister in an uninflated, folded condition. In practice, an airbag cushion for the protection of a front seat passenger in the event of a vehicular frontal impact is typically of a substantially larger size, e.g., larger volume, than a corresponding airbag cushion for the protection of the vehicle driver. Consequently, an inflator device associated with the inflation of a passenger airbag cushion must typically provide a substantially greater relative volume or amount of inflation gas in a timely and effective manner.

Reaction canisters which contain an airbag cushion for the protection of a front seat passenger commonly have a rectangular cross sectional shape and form a correspondingly shaped opening wherethrough the airbag cushion is deployable. Normally, a passenger side airbag module assembly is mounted in or behind what is called the vehicle instrument panel or dashboard (hereinafter referred to as the “instrument panel”), with the airbag deployment opening of the reaction canister generally positioned planar or adjacent the instrument panel.

The size of the airbag deployment opening, e.g., the length and width of the rectangular shaped opening, is normally determined by the need to provide a particular desired airbag cushion deployment. Thus, it is common that reaction canisters have a length predetermined by the size of the inflatable airbag cushion which is to be housed therein.

Various types of inflator devices have been disclosed in the art for the inflation of airbag cushions such as used in inflatable restraint systems. One type of known inflator device derives inflation gas from a combustible pyrotechnic gas generating material which, upon ignition, generates a quantity of gas sufficient to inflate the airbag. Such inflator devices also commonly include or incorporate various component parts including: a pressure vessel wherein the pyrotechnic gas generating material is burned; various filter or inflation medium treatment devices to properly condition the inflation medium prior to passage into the associated airbag cushion and a diffuser to assist in the proper directing of the inflation medium into the associated airbag cushion.

In typical passenger airbag module assemblies, the inflator (sometimes hereinafter referred to as a “passenger inflator”) has a generally hollow outer housing structure, which is generally of an elongated cylindrical or tubular shape. The size of the gas generant load contained within such an inflator housing structure is generally predetermined in order to be sufficient to result in desired inflation of the associated airbag cushion upon actuation of the inflator.

As identified above, airbag cushions for the protection of a front seat passenger in the event of a vehicular frontal impact are typically substantially larger in size, e.g., have a substantially larger volume, than corresponding airbag cushions for driver protection. In view thereof, typical pyrotechnic passenger inflators have an inflation gas output in the range of about 3-4.5 moles of gas, as compared to typical pyrotechnic driver inflators which have an inflation gas output in the range of about 1-1.5 moles of gas.

In typical inflatable restraint systems, specific passenger modules are themselves commonly sized dependent upon the shape and size of the corresponding inflator. For example, such passenger modules have typically had a specific cylindrical diameter to permit a tubular style inflator device to be housed within the reaction canister. The sizing of the module is then typically completed based on the length and diameter of the inflator that will be used. As will be appreciated, the incorporation and use of a different sized inflator in such applications such as to change or alter the inflation performance provided by the system will commonly necessitate the use of a reaction canister having a correspondingly different diameter or length. Consequently, significant design changes may be required to permit the incorporation and use of such a system between applications requiring or desiring different inflation performances.

Further, it has typically proven difficult to fully seal an elongated cylindrically shaped passenger inflator in an associated module housing. In particular, difficulty in sealing around the ends of such inflators contained in such a module housing can lead to an undesirable leakage of gas from the ends of the housing, with such leaked gas not being properly directed into the associated inflatable restraint device. Consequently, a larger than otherwise desired inflator may be needed in order to compensate for such leakage.

Still further, larger than desired module assemblies can be more costly to manufacture, assemble and produce and may unduly or unnecessarily limit the range of module design variation and placement within a vehicle.

In contrast to the elongated cylindrical shape of typical passenger inflators, typical airbag inflator devices used in association with frontal impact driver protection (sometimes hereinafter referred to as a “driver inflator”) have the general form of a flattened, disk-shaped circular cylinder typically or generally having a length (sometimes referred to as “height”) to diameter ratio of about 0.5 or less. For example, a typical driver inflator might be about 40 mm in length or height and about 80 mm in diameter.

Previous efforts to employ similar disk-shaped inflators for passenger applications have generally suffered from various limitations and complications. For example, at least two disk-shaped inflators have generally been previously required in order to provide sufficient inflation gas for inflation of the larger size airbag cushions employed in passenger applications.

Further, previous disk-shaped driver inflators have commonly employed or utilized a structural tie between selected inflator component parts, such as a structural tie of a retainer disk to an igniter tube or the like, in an effort to assure that the gas generant remains properly positioned and packaged through processing of the inflator. Unfortunately, such a structural arrangement can undesirably complicate the manufacture and production processes.

In addition, in view of possibly varying operating conditions and, in turn, possibly varying desired performance characteristics, there is a need and a desire to provide what has been termed an “adaptive” inflator device and a corresponding inflatable restraint system. With an adaptive inflator device, output parameters such as one or more of the quantity, supply, and rate of supply of inflation gas, for example, can be selectively and appropriately varied dependent on selected operating conditions such as ambient temperature, occupant presence, seat belt usage and rate of deceleration of the motor vehicle, for example.

While such adaptive systems are desirable, they typically require the inclusion of additional components as a part of the associated inflator device. As will be appreciated, the inclusion of such additional components may undesirably increase one or more of the size, cost and weight of the inflator device. In view thereof, it has been difficult to provide an adaptive inflator which will satisfactorily meet the size, cost and weight limitations associated with modem vehicle design, particularly as it pertains to passenger side applications.

Thus, there is a need and a demand for an adaptive inflator device of relatively simple design and construction and, in turn, comparatively, low or reduced cost. In particular, there is a need and a demand for such an adaptive inflator device which will meet the size requirements for vehicles, especially for passenger applications.

### SUMMARY OF THE INVENTION

A general object of the invention is to provide an improved vehicular inflatable restraint system inflator device.

A more specific objective of the invention is to overcome one or more of the problems described above.

The general object of the invention can be attained, at least in part, through a vehicular inflatable restraint system inflator device having a specific construction and which, upon actuation discharges sufficient inflation gas to inflate a passenger inflatable airbag cushion. The inflator device includes a housing having a disk form and defines a first chamber. In a static state, the first chamber contains a quantity of a first gas generant material ignitable to produce first combustion products including a first inflation gas. The housing also has at least two rows of spaced apart gas exit ports adapted to permit passage of the first inflation gas from the inflator devices into an associated inflatable airbag cushion. The first chamber also contains at least one inflation gas-permeable treatment element disposed between the quantity of the first gas generant material and the spaced apart gas exit ports, wherein passage of gas through the treatment element results in treatment thereof. The first chamber also contains a second chamber. In a static state, the second chamber has an enclosed volume containing a quantity of a second gas generant material ignitable to produce second combustion products. The second chamber has a lid closure adapted to permit fluid communication of the second combustion products with the contents of the first chamber. The inflator device also includes a first initiator device operatively associated with the first chamber and a second initiator device operatively associated with the second chamber.

The prior art generally fails to provide a passenger vehicular inflatable restraint system inflator device having a disk form or shape and which upon actuation discharges sufficient inflation gas to inflate a passenger inflatable airbag cushion without necessitating the incorporation and use of multiple inflator devices. As detailed herein below, the invention provides such an inflator device and with it, various associated or related benefits such as: improved fit and/or seal, minimization or reduction of inflation gas loses from corresponding or associated module assemblies, reductions in inflator device size, reduction in the required amount of gas generant to effect desired inflation of an associated airbag cushion, as well as simplified and/or reduced cost manufacture, production and assembly, for example.

The invention further comprehends a passenger vehicular inflatable restraint system inflator device which upon actuation discharges sufficient inflation gas to inflate a passenger inflatable airbag cushion, wherein the inflator device discharges at least 2 moles of inflation gas.

The passenger vehicular inflatable restraint system inflator device includes a housing. The housing has a disk form and defines a first chamber having a cylindrical outer wall. The first chamber in a static state contains a quantity of a first gas generant material ignitable to produce first combustion products including a first inflation gas. The housing includes a plurality of rows of spaced apart gas exit ports in the cylindrical outer wall. The gas exit ports are adapted to permit passage of the first inflation gas from the inflator device into an associated inflatable airbag cushion. The first chamber contains at least one inflation gas-permeable treatment element disposed between the quantity of the first gas generant material and the spaced apart gas exit ports, wherein passage of gas through the treatment element results in treatment thereof. The first chamber also contains a second chamber. The second chamber in a static state has an enclosed volume which contains a quantity of a second gas generant material ignitable to produce second combustion products. The second chamber has a lid closure adapted to permit fluid communication of the second combustion products with the contents of the first chamber.

The inflator device also includes a first igniter assembly operatively associated with the first chamber. The first igniter assembly includes a first initiator device and a supply of igniter material housed in a first igniter assembly housing, wherein actuation of the first initiator device produces a discharge in reaction initiating communication with at least a portion of the supply of the igniter material housed within the first igniter assembly housing and wherein the first igniter assembly housing includes a plurality of openings to permit passage of igniter material reaction products therethrough and into reaction initiating communication with at least a portion of the quantity of the first gas generant material contained in the first chamber.

The inflator device further includes a second initiator device operatively associated with the second chamber.

As used herein, references to the detection or sensing of “occupant presence” are to be understood to refer to and include detection and sensing of size, weight, and/or positions of the particular occupant under consideration.

References to inflator or inflation gas “output” are to be understood to refer to inflator performance output parameters such as the quantity, supply, and rate of supply of inflation gas. With “adaptive output inflators,” the inflator output is generally dependent on selected operating conditions such as ambient temperature, occupant presence, seat belt usage and rate of deceleration of the motor vehicle, for example.

References to “unused volume” within an inflator assembly are to be understood to generally refer to that space or volume within an inflator assembly occupied by an inert material element and which does not itself contribute to the practical inflation performance of the inflator assembly. For example, spacer elements such as found in various inflator assemblies generally constitute a common example of “unused volume.”

Other objects and advantages will be apparent to those skilled in the art from the following detailed description taken in conjunction with the appended claims and drawings.

### BRIEF DESCRIPTION OF THE DRAWINGS

FIG. 1 is a partial cross-sectional side view of an airbag inflator in accordance with one embodiment of the invention.

FIG. 2 is a bottom plan view of the airbag inflator of FIG. 1.

FIG. 3 is a side plan view, partially in section, of the airbag inflator of FIG. 1.

FIG. 4 is a partial cross-sectional side view of an airbag inflator in accordance with an alternative embodiment of the invention.

### DETAILED DESCRIPTION OF THE INVENTION

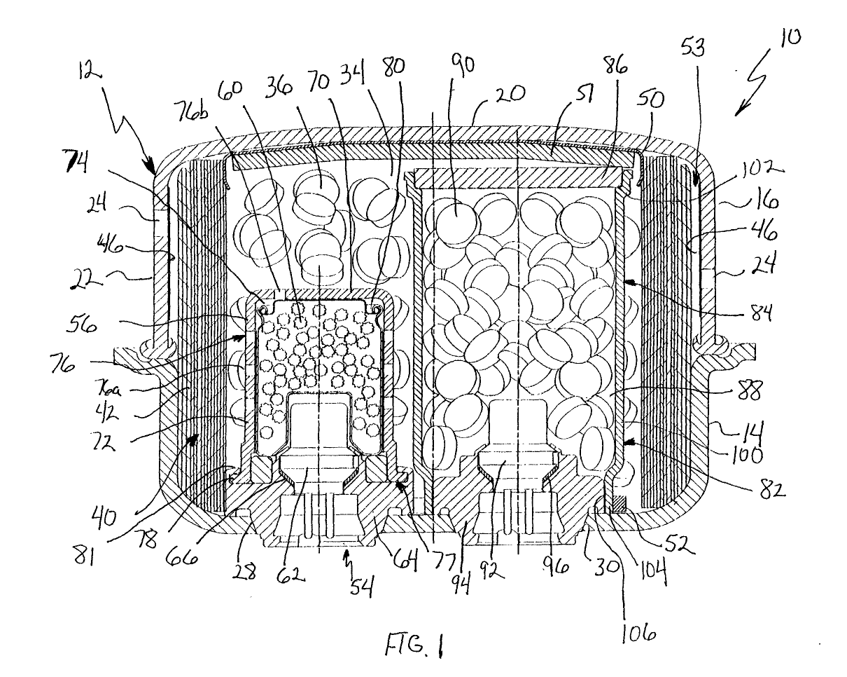

FIGS. 1-3 illustrate an adaptive output passenger disk inflator assembly in accordance with a one embodiment of the invention and generally designated with the reference numeral 10. The invention will be described hereinafter with particular reference to an inflatable restraint system installation for the protection of a front seat passenger in the event of a vehicular frontal impact, sometimes referred to herein as a “passenger airbag inflatable restraint system installation” or the like. Thus, inflator devices in accordance with a preferred practice of the invention will desirably discharge at least 2 moles of inflation gas and, in accordance with certain preferred embodiments, have an inflation gas output in the range of about 3-4.5 moles of gas. Such inflator devices in accordance with the invention are in sharp contrast to driver inflators which, as described above, may typically have an inflation gas output in the range of only about 1-1.5 moles of gas. It will be understood by those skilled in the art and guided by the teachings herein provided that the invention has general applicability to such inflatable restraint installations for various automotive vehicles including vans, pick-up trucks, and particularly automobiles.

The inflator assembly 10 has a generally cylindrical external outline and includes a housing construction 12 such as formed of two structural components, i.e., a lower shell or base portion 14 and an upper shell or diffuser cap portion 16, such as may desirably be made of steel and appropriately joined or fastened together such as by application of an appropriate welding operation. The housing 12 is illustrated in the general form of a flattened, disk-shaped circular cylinder and desirably has a length (denominated “L”) to diameter (denominated “D”) ratio of at least about 0.6 and no more than about 1.0 and, preferably, an L/D in a range of at least about 0.7 and no more than about 0.8, as such inflator designs can desirably provide the needed volume to contain a quantity of gas generant material sufficient to effect desired inflation of a passenger airbag cushion while minimizing the overall design envelope required by or for such an installation. It will be appreciated that such a sized and shaped housing has a length to diameter ratio significantly greater that the length to diameter ratio of about 0.5 or less such as associated with driver inflator devices and which may most conveniently correspond to the size and shape of the vehicle steering wheel.

The use of such a shaped passenger inflator device or assembly in accordance with the invention desirably facilitates and permits the use of driver inflatable restraint module concepts for or in association with the packaging of the inflator. In practice, such a shaped inflator assembly can better fit and seal within an associated module assembly such as to avoid or otherwise minimize the loss of inflation gas from the module assembly, e.g., where “loss of inflation gas” refers to inflation gas which is not used or otherwise desirably applied to the inflation of an associated inflatable safety restraint. As identified above, it has typically proven difficult to fully seal a traditional elongated cylindrically shaped passenger inflator in an associated module housing. Thus, at least in part due to improvements in fit and packaging realized through the practice of the invention, proper and desired inflation of an airbag cushion for the protection of a front seat passenger in the event of a vehicular frontal impact can desirably be realized using significantly less gas generant material than has been typically previously used for such applications. In turn, inflator devices required for such applications can be significantly reduced in size as compared to inflator devices commonly previously employed in such inflation applications.

The diffuser cap portion 16 is in the general form of an inverted bowl and includes a top wall 20 and a cylindrical sidewall 22. The sidewall 22 includes a plurality of spaced, preferably, generally spaced apart gas exit ports 24.

Those skilled in the art and guided by the teachings herein provided will appreciate that the placement, positioning and sizing of the gas exit ports can desirably be selected to provide or satisfy particular inflator performance criteria. For example, in accordance with a preferred embodiment of the invention and as shown in FIG. 2, the gas exit ports 24 can desirably be formed in two or more longitudinally offset rows of holes, designated 25 and 26, respectively. In accordance with one preferred embodiment of the invention, the holes in row 25 are also desirably laterally offset relative to the holes in row 26. Further and as described in greater detail below, the holes in each of the rows 25 and 26 can desirably be of two or more sizes, e.g., diameter in the case of circular holes. For example, in the inflator assembly 10 and as perhaps best seen by reference to FIG. 2, the holes in row 25 includes alternating holes of smaller diameter 25a and holes of larger diameter 25b. Similarly, the holes in row 26 includes alternating holes of smaller diameter 26a and holes of larger diameter 26b.

Those skilled in the art and guided by the teachings herein provided will appreciate that the incorporation and utilization of a combination of smaller and larger diameter holes such as described above can advantageously provide a simple means for pressure regulation within the subject inflator device such as for when the inflator device is fired at either or both various temperatures and with different gas generant loads, for example. In practice, pressure regulation within an inflator device is generally desired and required in order to maintain the combustion pressure within reasonable limits. For example, if the combustion pressure becomes too high, the structural integrity of the device can be undesirably compromised. On the other hand, if the combustion pressure is too low, poor ignition of the generant material may occur, which can lead to production of incomplete products of combustion in greater than desired or tolerable amounts and poor performance. Further, it has been found to be generally desirable to include gas exit port holes of larger diameter, e.g., holes 25b and 26b, and gas exit port holes of smaller diameter, e.g., holes 25a and 26a, wherein the ratio of the diameter of the larger diameter holes to the diameter of the smaller diameter holes is in the range of about 1.2 to about 1.6. In accordance with one specific embodiment of the invention, it has been found useful to include ten (10) gas exit port holes in each of rows 25 and 26, with the gas exit port holes of smaller diameter 25a and 26a each being about 0.1 inches in diameter and the gas exit port holes of larger diameter 25b and 26b each being about 0.14 inches in diameter. Additional specifics with regard to the placement, positioning and sizing of the gas exit ports 24 will be described in greater detail below. As will be appreciated, the spacing of the gas exit ports 24, such as described above, is generally advantageous for airbag inflation performance as such spacing may serve to minimize or avoid undesired concentration or focusing of the impingement of exiting inflation gas onto the associated airbag cushion material.

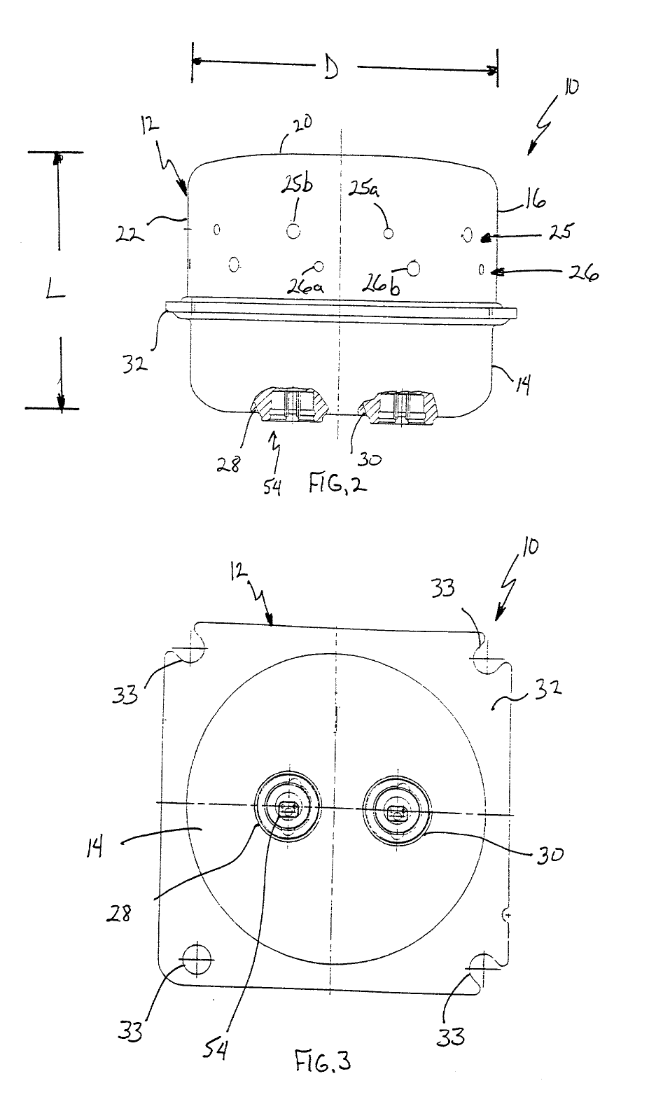

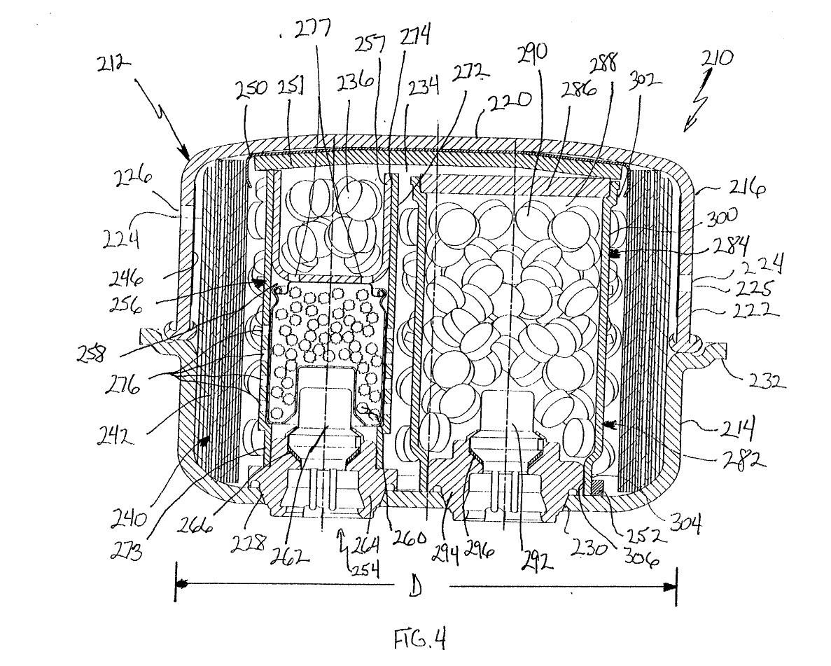

The base portion 14 includes first and second mounting openings, designated by the reference numerals 28 and 30, respectively, the use of which will be discussed in greater detail below. The base portion 14 also includes, perhaps as most clearly seen by reference to FIG. 3, a peripheral attachment flange 32 that extends radially outward from the housing 12. As shown in FIG. 3, the attachment flange 32 is generally square or rectangular in outline and includes a selected number of attachment openings 33 for passage of a selected fastener (not shown), e.g., a rivet or bolt, to permit the attachment or joinder of the inflator assembly 10 with a corresponding portion of the vehicle. As will be appreciated, attachment flanges used in the practice of the invention can be variously shaped and sized dependent upon the particulars of the specific installation application. Further, it is to be understood that while the invention has been here described making reference to the incorporation and use of such an attachment flange to permit the attachment or joinder of the inflator assembly 10 with a corresponding portion of the vehicle, the broader practice of the invention is not necessarily so limited. For example, an inflator assembly in accordance with the invention can be joined or attached within a module or the like using additional or alternative attachment devices or techniques, such as known in the art.

The housing 12 is configured to define a central, generally cylindrical first chamber 34. The first chamber 34 contains or houses a supply of a first gas generant material 36, typically in the form of a pyrotechnic, such as known for use in airbag inflators, such as composed of a transition metal ammine nitrate with oxidizer and binder, for example. Surrounding the first gas generant material 36 is a treatment or filter assembly 40 such as includes one or more inflation gas-permeable treatment elements such as in the form of a combustion screen or filter 42 such as formed of multiple layers or wraps of a metal screen. In general, inflation gas-permeable treatment elements useful in the practice of the invention desirably perform one or more functions or operations on a contacting stream, e.g., the generated or produced inflation gas, such as the cooling, flow redirection or filtering, e.g., particulate removal, of or from the contacting stream.

Surrounding the filter 42 and generally adjacent the inner surface of the sidewall 22 is an adhesive-backed foil seal 46. The foil seal 46 preferably hermetically seals the gas generant material 36 within the inflator 10, thereby protecting the gas generant material from various possibly harmful ambient conditions, such as including moisture. As will be appreciated, the need or desire to provide adequate surface area along the inner surface of the sidewall 22 such as to permit and facilitate attachment of the foil seal 46 thereto can serve as a practical or manufacturing limitation on the spacing of the gas exit ports 24.

The inflator assembly 10 also includes a retainer disk 50, with an associated, generally disk-shaped damper pad 51, and an annular base damper pad 52 serving as construction expedients retaining the inflator assembly components in proper relative arrangement and preventing undesired flow passage through the assembly.

In accordance with a preferred practice of the invention, the filter 42 of the filter assembly 40 is desirably of a press fit type. In particular, the filter 42 is desirably fitted and, in accordance with certain preferred practices of the invention, positionally maintained within the inflator assembly 10 via a press fit interference without requiring additional attachment or joinder expedients, as has been common in previous disk form inflators, as described above. For example, the filter 42 can be press fitted into the base portion 14 of the housing 12, as shown. Those skilled in the art and guided by the teachings herein provided will appreciate that as compared to typical disk type inflator devices for driver applications, the larger L/D ratios afforded by inflator devices in accordance with the invention desirably facilitate such assembly placement and securement of a filter. In particular, the large area interface between the filter assembly 40 and the base portion 14 provides increased and preferably sufficient engagement area therebetween to permit desired placement and securement of the filter assembly 40 without necessitating additional forms or types of attachment of the filter assembly to other inflator components. Further, the retainer disk 50 can, if desired and as shown, be simply press fitted within the filter 42 without requiring additional attachment or joinder expedients.

Further, in accordance with a preferred embodiment of the invention and as further described below, a plenum volume 53 is provided between the filter 42 and the inner surface of the sidewall 22.

A first igniter assembly, generally designated by the reference numeral 54, is mounted to the housing 12 in a location within the first chamber 34 via the first mounting opening 28. The first igniter assembly 54 may take a form such as includes an igniter tube 56 wherein is housed a supply of an igniter material 60, a first initiator device or squib 62, a squib adapter or holder 64 whereby the first igniter assembly 54 is mounted to or mated with the housing 12 and a squib seal 66, sealing the squib 62 with the adapter 64. As shown, the igniter tube 56 can take the form of a generally concave member with a cap 70 and a cylindrical sidewall 72 forming an interior 74. While the cap 70 and the cylindrical sidewall 72 of the igniter tube 56 are shown as having a one-piece construction, it will be understood by those skilled in the art and guided by the teachings herein provided that the broader practice of the invention is not necessarily so limited. For example, if desired, the igniter tube cap and sidewall can be separate pieces such as appropriately joined or connected.

The igniter tube 56 can be formed of a gas-impermeable material, such as metal, and include a plurality of spaced apart and specifically sized gas exit orifices 76, including gas exit orifices 76a in the sidewall 72 and gas exit orifices 76b (only one of which is visible in FIG. 1) in the cap 70. In particular, the gas exit orifices 76 are desirably appropriately sized, shaped, positioned and arranged to focus the ignition products resulting from reaction of the igniter material 60 into the bed of gas generant material 36 contained within the first chamber 34. As will be described in greater detail below, the tube sidewall 72 has an open end 77 whereat is formed or included a outwardly extending attachment lip 78.

The supply of the igniter material 60 can desirably be normally (e.g., when the inflator is in a static or prior to actuation state) contained within the igniter tube 56 in a closed canister, cartridge or container 80, such as known in the art. As will be appreciated by those skilled in the art and guided by the teachings herein provided, such a canister 80 can be variously constructed such as facilitate either or both loading and operation. For example, such a canister can be formed or constructed of a relatively thin metal such as to permit the igniter material to be appropriately loaded therewithin in a remote location or a selected point in time and then subsequently loaded or incorporated into a desired igniter or inflator assembly. Further, such closed containment can serve to avoid or at least minimize the occurrence or possibly detrimental contacts by or between the supply of the igniter material 60 and the ambient environment outside the canister 80.

When actuated, ignition of the supply of the igniter material 60 customarily results in an increase in pressure within the canister 80 with the subsequent predetermined rupturing or opening of the canister 80 to permit passage of ignition products produced by the combustion of the igniter material 60 through the exit orifices 76, from the first igniter assembly 54 to the gas generant material 36 contained within the first chamber 34. The resulting contact by or between the ignition products and the gas generant material results in the ignition and reaction of the gas generant material to form or produce first combustion products including a first inflation gas, with the gas so produced at least in part passing through the filter 42 and into the plenum 53. As will be appreciated, the contact of ignition products with the gas generant material can appropriately be, either or both, thermal or physical in nature.

The plenum 53 provides or serves as a volume of space or a zone where the inflation gas can pass such that when the pressure within the plenum 53 becomes sufficiently elevated, such as to achieve a predetermined level, the foil seal 46 will rupture and permit gas to pass through the gas exit ports 24. The presence of the plenum 53 facilitates a more uniform distribution of the inflation gas within the inflator assembly 10 and access to the gas exit ports 24. Further, the presence of the plenum 53 can help minimize or avoid undesired contact by or between the filter 42 and the inner surface of the diffuser cap portion cylindrical sidewall 22 and such as can result in undesirable fragmentation of the filter 42 or other form of damage to the filter 42. In practice, inflator assemblies in accordance with the invention and having a plenum 53 having a width (as measured traverse between the inner surface of the sidewall 22 and the outer surface of the filter 42) of about 1 mm to about 1.5 mm and, in accordance with one specific embodiment, a width of 1.35 mm have been found useful in various airbag applications for the purposes identified above.

In such an igniter assembly, the igniter tube 56 can desirably be sized to meet the requirements for the amount of the igniter material 60 to be therewithin contained while minimizing or avoiding the amount of unused volume formed or created in the inflator assembly 10. As a result, the size of specific such inflator assemblies in accordance with the invention can desirably be reduced or minimized. Consequently, the cost, weight and/or size of such inflation assemblies can corresponding be similarly reduced and/or minimized.

In practice, the first igniter assembly 54 can be formed by placing the igniter tube 56, containing the canister 80 containing the supply of the igniter material 60, over the squib 62 and the squib adapter or holder 64. While the broader practice of the invention is not necessarily limited by the method or technique used for joining or attaching the igniter tube 56 to or with the squib adapter or holder 64, in accordance with one preferred embodiment of the invention, the squib adapter or holder 64 includes a crimpable flange 81 that, as shown in FIG. 1, can desirably be crimped over the outwardly extending attachment lip 78 of the igniter tube 56 to form a secure attachment. Those skilled in the art and guided by the teachings herein provided will appreciate that such a crimped form of joinder can desirably reduce or minimize the loss of ignition material or energy that might otherwise result from an inflator design which employs a press fit attachment of a corresponding igniter tube and squib adapter. In addition to reducing or minimizing the loss of ignition products, e.g., including heat or energy, out of the open end of the igniter tube, such a crimped form of attachment serves to focus, force or direct the ignition products through the gas exit orifices 76 that appropriately focus the ignition products resulting from reaction of the igniter material 60 into the bed of gas generant material 36 contained within the first chamber 34.

The first igniter assembly 54 may then be joined to the housing 12. For example, the holder 64 can be first welded to the base portion 14 at the mounting opening 28. The first igniter assembly 54 can then be joined to the holder 64 by crimping the flange 81 over the first igniter assembly 54, as shown in FIG. 1.

The first chamber 34 also houses or contains a second chamber 82. The second chamber 82 includes a generant cup 84 and a lid closure 86. The generant cup 84 and the lid closure 86 cooperate to form a generant cup interior 88 wherein is desirably placed a selected quantity of a second gas generant material 90 such as typically in the form of a pyrotechnic. The second gas generant material 90 may typically be in the form of a pyrotechnic material and may be either the same or different in composition, shape, size or form, as compared to the first gas generant material 36.

The second chamber 82 also includes a second initiator device or squib 92, a second squib adapter 94 whereby the second chamber 82 is mounted to or mated with the housing 12 and a second squib seal 96, sealing the squib 92 with the adapter 94.

The generant cup 84 desirably includes a generally cylindrical sidewall 100 and such as preferably includes a shoulder portion 102 such as formed therein. The lid closure 86 and the shoulder portion 102 may desirably form a press or interference fit form of attachment when in a static state or condition. The generant cup 84 also includes a base portion 104 such as integrally formed in one piece with the generally cylindrical sidewall 100. The base portion 104 includes an opening 106 wherethrough the second squib adapter 94 may be passed and joined such as by press fitting the base portion 104 over the adapter 94. It will be appreciated that the generant cup 84 can be joined, attached or connected to or with the adapter 94 by other appropriate and selected methods such as will be apparent to those skilled in the art and guided by the teachings herein provided.

The generant cup 84 and the lid closure 86 can each selectively be formed of a gas-impermeable material, such as metal, such as ASTM A1011 HSLAS-F steel, for example. In accordance with a preferred practice of the invention, the generant cup 84 and the lid closure 86 cooperate and function in a manner such as to prevent the combustion products resulting upon actuation of the first squib 62 to enter into the second chamber 82. For example and as shown, the lid closure 86 may desirably form a press fit seated engagement with the shoulder portion 102 such as to prevent passage into the second chamber 82 of the combustion products resulting upon actuation of the first squib 62. As will be appreciated, the passage of such combustion products into the second chamber could otherwise result in the undesired ignition and reaction of the gas generant material 90 housed or contained within the second chamber 82. Further, the generant cup 84 and the lid closure 86 desirably cooperate and function in a manner such as to permit the combustion products formed by reaction of the gas generant material 90 contained within the second chamber 82, when properly and desirably actuated, to pass from the second chamber 82 out into the first chamber 34 and subsequently through the filter assembly 40, to the plenum 53 and then to the exit ports 24 out from the inflator assembly 10 and into an associated airbag cushion (not shown).

With actuation of the initiator device 92, the initiator device 92 releases ignition products which ignite the gas generant 90 to produce reaction products which result in an increase in pressure within the cup interior 88. When the pressure within the second chamber 82 reaches a predetermined level, such internal pressure acts or serves to pop-off or otherwise dislodge the lid closure 86 from the sidewall shoulder portion 102. As a result, a clearance space is formed between the dislodged lid closure 86 and the shoulder portion 102 to permit the passage or escape of the combustion products from the second chamber 82 and subsequently pass, as may be desired, into the first chamber 34 and subsequently through the filter assembly 40 and out the exit ports 24. In practice, the lid closure 86 will generally remain seated relative to sidewall shoulder portion 102 until sufficient internal pressure is developed within the second chamber 82 to overcome the interference fit between the lid closure and the gas generant cup.

It will be appreciated that in such an arrangement or combination in accordance with the invention, such a pop-off lid closure acts or functions as a one-way valve. In particular, such a pop-off lid closure provides or results in an arrangement or combination which desirably functions to avoid or prevent material, such as the combustion products formed upon the actuation of the first squib 62, to enter into the second chamber generant cup interior 88 but which also permits the desired passage of the combustion products formed upon the actuation of the second squib 92 to exit from the second chamber 82 and subsequently pass, as may be desired, into the first chamber 34 and subsequently through the filter assembly 40 and out the exit ports 24.

The lid closure 86 is desirably constructed of a sufficiently strong material to remain intact, e.g., in significantly one-piece, even upon application of sufficient pressure thereagainst such as to result in the lid closure popping off or otherwise becoming dislodged from engagement with the gas generant cup. Those skilled in the art and guided by the teachings herein provided will appreciate that the thickness of lid closures useable in the practice of the invention can generally vary dependent on features such as the strength of the material of construction and the diameter of lid closure required to close the associated generant cup, for example. In practice, lid closures such as fabricated of ASTM A1011 HSLAS-F steel and having a thickness of about 2-3 mm have been found useful and effective in the general practice of the invention. More specifically, lid closures in accordance with the invention and as described above desirably advantageously provide or result in the maintenance of either and, preferably, both, a pressure and a thermal boundary between the respective gas generant material charges until such time that the particular charge is desired to be ignited. For example, the greater thickness of lid closures in accordance with the invention, as compared to typical or usual burst disks used in typical inflator devices, generally provides in significantly improved maintenance of a desired and effective thermal boundary between the respective gas generant material charges until such time that the particular charge is desired to be ignited.

It will be appreciated that an inflator assembly in accordance with the invention can provide operation performance in accordance with selected operating conditions as may be required or desired for particular inflatable restraint system installations and applications. More specifically, an inflator assembly of the invention can be actuated in a manner such that either or both the quantity or rate of inflation gas production can be appropriately varied, such as at the time of a vehicle crash or collision incident, to take into account one or more conditions of occupant presence, as described above. Such inflator performance adaptability results from the subject inflator having two discrete and ballistically isolated chambers of gas generant materials. The subject inflator permits several distinct inflation performance scenarios:

For example, such an inflator assembly can be operated to have a first stage discharge whereby the first initiator device 62 of the first igniter assembly 54 is actuated such that the supply of the igniter material 60 is ignited to produce ignition products which are passed to the first gas generant chamber 34 to ignite the first gas generant material 36 therein contained to produce inflation gas at a first output level without actuating or firing the second initiator device or squib 92 and thus reacting or activating the gas generant material 90 contained in the second chamber 82. As will be appreciated, such operation may be desired to provide a minimized or reduced inflator output such as may be desired in an instance of a low speed collision, for example.

Alternatively, an inflator assembly in accordance with the invention can be operated such that both the first and second initiator devices, 62 and 92, respectively, are actuated.

As will be appreciated, such operation and subsequent resulting ignition of both the first and second gas generant materials, 36 and 90, respectively, can involve the simultaneous or near simultaneous actuation and firing of the first and second initiator devices (such as may be desired in order to provide a very rapid inflation and deployment of an associated airbag cushion, as may be desired in response to a high speed or severe vehicle collision) or the sequential actuation and firing of the first and second initiator devices (such as may be desired upon the occurrence of a moderately severe vehicle collision). Further, with such sequential actuation and firing, the time lag or delay between the actuation and firing of the first and second squibs and, in turn, the ignition of the first and second gas generant materials can be tailored to meet the specific requirements for a particular inflatable restraint system installation, as will be appreciated by those skilled in the art. Thus, such inflator assemblies are particularly suited for application as adaptive output inflators such as can be made generally dependent on one or more selected operating conditions such as ambient temperature, occupant presence, seat belt usage and rate of deceleration of the motor vehicle, for example.

In accordance with a preferred practice of the invention, the lid closure 86 desirably remains intact upon opening, such that the lid closure 86 can desirably serve to facilitate radial flow of the combustion products out from the second chamber 82 and into the first chamber 34. For example, when both the first and second initiator devices, 62 and 92, respectively, are simultaneously actuated or fired, the ignition energy from the first chamber can desirably serve to accelerate combustion within the second chamber.

The inflator assembly 10, rather than relying on separate filter assemblies for each chamber or stage of the inflator, as is common with various prior art dual stage inflator devices, employs or utilizes a single filter assembly 42 for the filtration or treatment, e.g., cooling, of the inflation products produces from both the first and second chambers. Further, such use of a single filter assembly rather the use of two or more filter assemblies can serve to reduce or eliminate the need for the inclusion of multiple filter assembly seals. Still further, the inflator assembly 10 includes a single diffuser rather than requiring separate diffusers for each chamber or stage contained therein.

As will be appreciated, reductions in the number of parts in an inflator assembly can simplify inflator design, reduce manufacturing and production costs, reduce assembly weight and result in an assembly requiring a smaller volume of space within a vehicle. For example, the use of a single filter or filter assembly for the filtration of the inflation products of the inflation discharge of both the first and second chambers can simplify system design and result in better utilization of space within the inflator assembly. Thus, facilitating the design of an adaptive inflator assembly to be generally housed within a design envelope of significantly reduced geometry.

The invention in its broader application is not limited to the use of a particular or specific gas generant. As those skilled in the art will appreciate, the invention can be practiced using a wide variety of gas generant materials which meet flame temperature, stability, filterability, toxicity, corrosivity, and gas generation requirements. As will be appreciated, gas generant materials, e.g., pyrotechnics, useful in the practice of the invention can take various appropriate desired forms, including, for example, various extruded forms as well as granulated materials. The invention, in its broader practice, is not limited to particular or specific forms of gas generant materials. Further, it is to be appreciated that while an inflator assembly in accordance with the invention may utilize a gas generant material of the same composition and physical form or parameters as both the first and second gas generant materials, the broader practice of the invention is not so limited. For example, it specifically may be desired that the first gas generant material be relatively slow burning so as to result in or provide a slower or gentler onset of inflation of the associated airbag cushion and that the second gas generant material be relatively quick burning to provide a quicker or faster inflation rate for the associated airbag and such as may be desired in the occurrence of the associated vehicle being involved in a relatively severe collision or crash. Such difference in performance can be realized through the use of gas generant materials of different composition as the first and second gas generant materials. Alternatively or additionally, the first and second gas generant materials can be in different physical form or have different physical parameters, e.g., shape and size. For example, to provide a faster or more rapid burning material it may be desirable to employ a form of the material having an increased or greater surface area.

Thus, the invention provides an adaptive passenger inflator device of a disk form and corresponding operation in which two separate or distinct charges are desirably isolated until the respective desired actuation thereof and which subsequently permit the desired flow of the combustion products resulting from the combustion of each charge of each chamber into communication with the contents of the other chamber and ultimately to exit from the inflator. The invention further provides an adaptive passenger inflator device having a disk form or shape and which is desirably of relatively simple design and construction and which, desirably, is of comparatively low or reduced cost. The invention in particular provides such an adaptive passenger inflator device which will better fit and seal within a module assembly such as to reduce or minimize loss of inflation gas from the module. As a result, significantly less gas generant material may be required within such an inflator device such as to permit the use of an inflator, the size of which, has been significantly reduced. For example, the placement and positioning of a disk form inflator in accordance with the invention in an associated reaction canister or module housing may simply involve placement of the inflator in or through a hole in the canister or module housing. Differences in inflator performance that can be accomplished by simply changing the height of the inflator do not affect the module. Further, changes in the diameter of the inflator disk can simply be compensated for by appropriately changing the dimensions of the attachment flange.

Turning now to FIG. 4, there is illustrated an adaptive output passenger disk inflator assembly, generally designated with the reference numeral 210, in accordance with another preferred embodiment of the invention. In particular, FIG. 4 illustrates the disk inflator assembly 210 while in a static state or condition, e.g., prior to actuation, and generally corresponding to the view shown in FIG. 1.

The inflator assembly 210 is similar to the inflator assembly 10 described above in that, for example, it includes a housing construction 212 having a generally cylindrical external outline and such as formed of two structural components, i.e., a lower shell or base portion 214 and an upper shell or diffuser cap portion 216, such as may desirably be made of steel such as identified above and appropriately joined or fastened together such as by application of an appropriate welding operation. The housing 212 is illustrated in the similar general form of a flattened, disk-shaped circular cylinder typically or generally having a length to diameter ratio in the range of about 0.6 to about 1.0 and, preferably in a range of about 0.7 to about 0.8, as identified above.

Similar to the diffuser cap portion 16, in the above-described inflator assembly 10, the diffuser cap portion 216 is in the general form of an inverted bowl and includes a top wall 220 and a cylindrical sidewall 222, which includes a plurality of spaced apart gas exit ports 224. As with the inflator assembly 10, the placement, positioning and sizing of the gas exit ports 224 can desirably be selected to provide or satisfy particular inflator performance criteria. For example, the gas exit ports 224 can desirably be formed in two or more rows of holes, designated 225 and 226, respectively. Those skilled in the art and guided by the teachings herein provided will appreciate that, as described above, various arrangements of gas exit ports can be used in the practice of the invention and thus the broader practice of the invention is to be understood as not limited to a specific or particular arrangement thereof.

The base portion 214 includes first and second mounting openings, designated by the reference numerals 228 and 230, respectively. The base portion 214 also includes a peripheral attachment flange 232, as described above, that extends radially outward from the housing 212. As described above, the incorporation and use of such an attachment flange 232 facilitates or permits the attachment or joinder of the inflator assembly with a corresponding portion of the vehicle.

The housing 212 is configured to define a central, generally cylindrical first chamber 234 which contains or houses a supply of a first gas generant material 236, such as described above. Surrounding the first gas generant material 236 is a treatment or filter assembly 240 such as includes one or more inflation gas-permeable treatment elements such as in the form of a combustion screen or filter 242 such as formed of multiple layers or wraps of a metal screen and desirably of a press fit type, as described above. Surrounding the filter 242 and generally adjacent the inner surface of the sidewall 222 is an adhesive-backed foil seal 246 which preferably hermetically seals the gas generant material 236 within the inflator 210, thereby protecting the gas generant material from various possibly harmful ambient conditions, such as including moisture.

The inflator assembly 210 also includes a retainer disk 250, with an associated, generally disk-shaped damper pad 251, and an annular base damper pad 252 serving as construction expedients retaining the inflator assembly components in proper relative arrangement and preventing undesired flow passage through the assembly.

A first igniter assembly, generally designated by the reference numeral 254, is mounted to the housing 212 in a location within the first chamber 234 via the first mounting opening 228. It is with respect to the first igniter assembly 254 that the inflator assembly 210 differs most significantly from the inflator assembly 10 described. In particular, whereas the inflator assembly 10 incorporated an igniter tube 56 generally sized for the amount of igniter material 60 to be therein contained, the inflator assembly 210 makes use of an elongated igniter tube 256 and an associated igniter tube insert or plug element 257 to form an igniter material volume 258 of a size selected to meet the needs and requirements for a particular inflatable restraint application. As will be appreciated, igniter tube inserts or plugs of various designs or configurations can be used in the broader practice of the invention. In accordance with the illustrated preferred embodiment of the invention, the igniter tube insert 257 is in the form of a cup such as made of ASTM A1011 HSLAS-F steel, for example, and such as press fitted within the igniter tube 256 to form the igniter material volume 258.

As with the first igniter assembly 54 described above, the first igniter assembly 254 contains a supply of an igniter material 260 and also includes a first initiator device or squib 262, a squib adapter or holder 264 whereby the first igniter assembly 254 is mounted to or is mated with the housing 212 and a squib seal 266, sealing the squib 262 with the adapter 264.

As shown, the igniter tube 256 is a generally hollow, open-ended cylinder composed of a sidewall 272 having a generally circular cross section. The igniter tube 256 includes generally opposed first and second open ends 273 and 274, respectively. The igniter tube sidewall 272 includes a plurality of spaced apart and specifically sized gas exit orifices 276. Similarly, the igniter tube insert 257 may, if desired and as preferably shown, also include a plurality of spaced apart and specifically sized gas exit orifices 277. In particular, the gas exit orifices 276 and, if included, the gas exit orifices 277 are desirably appropriately sized, shaped, positioned and arranged to focus the ignition products resulting from reaction of the igniter material 260 into the bed of gas generant material 236 contained within the first chamber 234.

As shown, the first igniter tube open end 273 is adapted to accept the squib adapter or holder 264 and then be securely joined therewith via a press fit of such first igniter tube open end 273. Such a press fit attachment serves to focus, force or direct the ignition products through the gas exit orifices 276 and, if included, the gas exit orifices 277, and such as may serve to appropriately focus the ignition products resulting from reaction of the igniter material 260 into the bed of gas generant material 236 contained within the first chamber 234.

The supply of the igniter material 260 normally (e.g., when the inflator is in a static or prior to actuation state) can be contained within the igniter tube 256 in a closed canister, cartridge or container 280, such as described above. In practice, the igniter tube gas exit orifices 276 are desirably spaced and positioned about the igniter tube sidewall 272 in the portion of the igniter tube 256 adjacent the igniter material 260.

As will be appreciated, with the inflator assembly design shown in FIG. 4, the placement of different quantities of igniter material 260 within the igniter tube 256 can easily be accomplished such as by changing the size of the igniter material volume 258 such as by simply changing either or both the size and placement of the igniter tube insert 257.

In addition to facilitating the tailoring of the design of particular inflator assemblies to meet the requirements of specific applications by facilitating the inclusion of a specifically selected amount of igniter material 260 therewithin, the inclusion and use of an igniter tube insert 257 in accordance with the invention also can desirably help ensure that the supply of igniter material 260 and the first initiator or squib 262 remain in proper and desired relative position to result in desired reaction of the igniter material upon actuation of the squib 262.

As with the above-described embodiment, ignition of the igniter material 260 upon actuation customarily results in an increase in pressure within the canister 280 with the subsequent predetermined rupturing or opening of the canister 280 to permit passage of ignition products produced by the combustion of the igniter material 260 through the exit orifices 276 and 277 and from the first igniter assembly 254 to the gas generant material 236 contained within the first chamber 234. The resulting contact by or between the ignition products and the gas generant material results in the ignition and reaction of the gas generant material, with gases so produced passing through the filter 242, rupturing the foil seal 246 and passing through the gas exit ports 224 and out from the inflator assembly 210 into an associated airbag cushion (not shown).

The first chamber 234 of the inflator assembly 210, similar to the first chamber 34 of the inflator assembly 10, described above, houses or contains a second chamber 282. The second chamber 282, similar to the second chamber 82 described above, includes a generant cup 284 and a lid closure 286 which cooperate to form a generant cup interior 288 wherein is desirably placed a selected quantity of a second gas generant material 290 such as typically in the form of a pyrotechnic. Again, the second gas generant material 290 may typically be in the form of a pyrotechnic material and may be either the same or different in composition, shape, size or form, as compared to the first gas generant material 236.

The second chamber 282 also includes a second initiator device or squib 292, a second squib adapter 294 whereby the second chamber 82 is mounted to or mated with the housing 212 and a second squib seal 296, sealing the squib 292 with the adapter 294.

The generant cup 284 desirably includes a generally cylindrical sidewall 300 and preferably includes a shoulder portion 302 such as formed therein. The lid closure 286 and the shoulder portion 302 desirably form a press or interference fit form of attachment when in a static state or condition. The generant cup 284 also includes a base portion 304 such as integrally formed in one piece with the generally cylindrical sidewall 300. The base portion 304 includes an opening 306 wherethrough the second squib adapter 294 may be passed and joined, such as in a manner known in the art.

As with the above-described embodiment, the generant cup 284 and the lid closure 286 desirably cooperate and function in a manner such as to prevent the undesired entry into the second chamber 282 of the combustion products resulting upon actuation of the first squib 262, Further, the generant cup 284 and the lid closure 286 desirably cooperate and function, such as described above, to permit the combustion products formed by reaction of the gas generant material 290 contained within the second chamber 282, when properly and desirably actuated, to pass from the second chamber 282 out into the first chamber 234 and subsequently through the filter assembly 240 and the exit ports 224 out from the inflator assembly 210 and into an associated airbag cushion (not shown).

The inflator assembly 210, similar to the inflator assembly 10, can be appropriately operated in accordance with selected operating conditions as may be required or desired for particular inflatable restraint system installations and applications, as described above.

While the invention has been described above relative to embodiments wherein an adhesive-backed foil is utilized to close or block mass flow through the gas exit ports in a static state, the broader practice of the invention is not necessarily so limited. For example, other means or techniques for closing or blocking mass flow through the gas exit ports in a static state will be apparent to those skilled in the art and guided by the teachings herein provided.

Thus, the invention provides a passenger vehicular inflatable restraint system inflator device having a disk form or shape and which upon actuation discharges sufficient inflation gas to inflate a passenger inflatable airbag cushion without necessitating the incorporation and use of multiple inflator devices. As detailed herein, the invention provides such an inflator device and with it, various associated or related benefits such as: improved fit and/or seal, minimization or reduction of inflation gas loses from corresponding or associated module assemblies, reductions in inflator size, reduction in the required amount of gas generant to effect desired inflation of an associated airbag cushion, as well as simplified and/or reduced cost manufacture, production and assembly, for example.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A vehicular inflatable restraint system inflator device comprising:
a housing, the housing having a disk form and defining a first chamber, the first chamber in a static state containing a quantity of a first gas generant material ignitable to produce first combustion products including a first inflation gas, the housing having at least a first and a second row of spaced apart gas exit ports adapted to permit passage of the first inflation gas from the inflator device into an associated inflatable airbag cushion;
the first chamber containing at least one inflation gas-permeable treatment element disposed between the quantity of the first gas generant material and the at least two rows of spaced apart gas exit ports, wherein passage of gas through the treatment element results in treatment thereof;
the first chamber also containing a second chamber; the second chamber in a static state having an enclosed volume containing a quantity of a second gas generant material ignitable to produce second combustion products; the second chamber having a lid closure adapted to permit fluid communication of the second combustion products with the contents of the first chamber;
a first initiator device operatively associated with the first chamber; and
a second initiator device operatively associated with the second chamber;
the inflator device discharging sufficient inflation gas to inflate a passenger inflatable airbag cushion.

2. The vehicular inflatable restraint system inflator device of claim 1 additionally comprising a barrier closing the gas exit ports to mass flow in a static state.

3. The vehicular inflatable restraint system inflator device of claim 1 wherein the device has a gas output of at least 2 moles of inflation gas.

4. The vehicular inflatable restraint system inflator device of claim 3 wherein the device has a gas output in a range of about 3-4.5 moles of inflation gas.

5. The vehicular inflatable restraint system inflator device of claim 1 wherein the housing has a length to diameter ratio of at least about 0.6.

6. The vehicular inflatable restraint system inflator device of claim 5 wherein the housing has a length to diameter ratio of no more than about 1.0.

7. The vehicular inflatable restraint system inflator device of claim 6 wherein the housing has a length to diameter ratio in a range of at least about 0.7 and no more than about 0.8.

8. The vehicular inflatable restraint system inflator device of claim 1 wherein each of the first and second rows of spaced apart gas exit ports comprises a plurality of holes with the holes of the first row offset relative to the holes of the second row.

9. The vehicular inflatable restraint system inflator device of claim 8 wherein the holes of at least the first row includes a plurality of holes of a first diameter and a plurality of holes of a second diameter and wherein the ratio of the first diameter to the second diameter is in a range of about 1.2 to about 1.6.

10. The vehicular inflatable restraint system inflator device of claim 9 wherein the first row includes at least first and second adjacent holes wherein the first adjacent hole is of the first diameter and the second adjacent hole is of the second diameter.

11. The vehicular inflatable restraint system inflator device of claim 1 wherein the holes of each of the first and second rows includes a plurality of holes of a first diameter and a plurality of holes of a second diameter and wherein the ratio of the first diameter to the second diameter is in a range of about 1.2 to about 1.6.

12. The vehicular inflatable restraint system inflator device of claim 11 wherein each of the first and second rows of gas exit ports includes alternating holes of the first and the second diameters.

13. The vehicular inflatable restraint system inflator device of claim 12 wherein:
the device has a gas output of at least 2 moles of inflation gas;
the housing has a length to diameter ratio of at least about 0.6 and
the holes of the first row are offset relative to the holes of the second row.

14. The vehicular inflatable restraint system inflator device of claim 1 wherein the at least one inflation gas-permeable treatment element is spaced apart from the at least two rows of spaced apart gas exit ports by a plenum.

15. The vehicular inflatable restraint system inflator device of claim 1 wherein at least one of the first and the second gas generant materials is a pyrotechnic material.

16. The vehicular inflatable restraint system inflator device of claim 1 wherein the first gas generant material and the second gas generant material is each a pyrotechnic material.

17. The vehicular inflatable restraint system inflator device of claim 1 wherein the first and second gas generant materials differ in at least one aspect selected from the group consisting of: composition, shape, form and size.

18. A passenger side vehicular inflatable restraint system inflator device comprising:
a housing, the housing having a disk form and defining a first chamber having a cylindrical outer wall, the first chamber in a static state containing a quantity of a first gas generant material ignitable to produce first combustion products including a first inflation gas, the housing including a plurality of rows of spaced apart gas exit ports in the cylindrical outer wall, the gas exit ports adapted to permit passage of the first inflation gas from the inflator device into an associated inflatable airbag cushion;
the first chamber containing at least one inflation gas-permeable treatment element disposed between the quantity of the first gas generant material and the spaced apart gas exit ports, wherein passage of gas through the treatment element results in treatment thereof;
the first chamber also containing a second chamber, the second chamber in a static state having an enclosed volume containing a quantity of a second gas generant material ignitable to produce second combustion products, the second chamber having a lid closure adapted to permit fluid communication of the second combustion products with the contents of the first chamber;
a first igniter assembly operatively associated with the first chamber, the first igniter assembly comprising a first initiator device and a supply of igniter material housed in a first igniter assembly housing, wherein actuation of the first initiator produces a discharge in reaction initiating communication with at least a portion of the supply of the igniter material housed within the first igniter assembly housing and wherein the first igniter assembly housing includes a plurality of openings to permit passage of igniter material reaction products therethrough and into reaction initiating communication with at least a portion of the quantity of the first gas generant material contained in the first chamber; and
a second initiator device operatively associated with the second chamber;
the inflator device discharging sufficient inflation gas to inflate a passenger inflatable airbag cushion, wherein the inflator device discharges at least 2 moles of inflation gas.

19. The passenger side vehicular inflatable restraint system inflator device of claim 18 wherein the first igniter assembly housing is sized to correspond the supply of igniter material housed therewithin.

20. The passenger side vehicular inflatable restraint system inflator device of claim 18 wherein the first igniter assembly additionally comprises an insert element joined to the igniter assembly housing, the insert element maintaining discharge reaction initiating communication between the first initiator device and the at least a portion of the supply of the igniter material housed within the first igniter assembly housing.

21. The passenger side vehicular inflatable restraint system inflator device of claim 18 including at least first and second rows of spaced apart gas exit ports in the cylindrical outer wall, wherein spaced apart gas exit ports of the first row are offset relative to the spaced apart gas exit ports of the second row.

22. The passenger side vehicular inflatable restraint system inflator device of claim 18 having a gas output in a range of about 3-4.5 moles of inflation gas.

23. The passenger side vehicular inflatable restraint system inflator device of claim 18 wherein the housing has a length to diameter ratio of at least about 0.6.

24. The passenger side vehicular inflatable restraint system inflator device of claim 23 wherein the housing has a length to diameter ratio of no more than about 1.0.

25. The passenger side vehicular inflatable restraint system inflator device of claim 24 wherein the housing has a length to diameter ratio in a range of at least about 0.7 and no more than about 0.8.

26. The passenger side vehicular inflatable restraint system inflator device of claim 18 wherein each of the first and second rows of spaced apart gas exit ports comprises a plurality of holes with the holes of the first row offset relative to the holes of the second row.

27. The passenger side vehicular inflatable restraint system inflator device of claim 26 wherein the holes of at least the first row includes a plurality of holes of a first diameter and a plurality of holes of a second diameter and wherein the ratio of the first diameter to the second diameter is in a range of about 1.2 to about 1.6.
